(19) United States
(12) Patent Application Publication
(10) Pub. No.: US 2010/0241600 A1
(43) Pub. Date: Sep. 23, 2010

(54) Method, Apparatus and Computer Program Product for an Instruction Predictor for a Virtual Machine

(75) Inventor: Andrey Krichevskiy, Farnborough (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/408,087

(22) Filed: Mar. 20, 2009

(51) Int. Cl. G06F 15/18; G06F 9/455

(52) U.S. Cl. 706/21; 718/1

(57) ABSTRACT

An apparatus for providing an instruction predictor for a virtual machine may include a processor and a memory storing executable instructions that in response to execution by the processor cause the apparatus to train a neural network to predict a future instruction corresponding to a current instruction based on past instructions provided to the neural network, and provide the future instruction predicted to a virtual machine to enable the virtual machine to manage operation of the virtual machine based on the future instruction. A corresponding method and computer program product are also provided.

### TECHNOLOGICAL FIELD

Embodiments of the present invention relate generally to mechanisms for increasing virtual machine processing speed and, more particularly, relate to a method, apparatus, and computer program product for providing an instruction or byte codes predictor for a virtual machine.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer and convenience to users relates to provision of various applications or software to users of electronic devices such as a mobile terminal. The applications or software may be executed from a local computer, a network server or other network device, or from the mobile terminal such as, for example, a mobile telephone, a mobile television, a mobile gaming system, etc, or even from a combination of the mobile terminal and the network device. In this regard, various applications and software have been developed and continue to be developed in order to give the users robust capabilities to perform tasks, communicate, entertain themselves, etc. in either fixed or mobile environments. However, many electronic devices which have different operating systems may require different versions of a particular application to be developed in order to permit operation of the particular application at each different type of electronic device. If such different versions were developed to correspond to each different operating system, the cost of developing software and applications would be increased.

Accordingly, virtual machines (VMs) have been developed. A VM is a self-contained operating environment that behaves as if it is a separate computer. The VM may itself be a piece of computer software that isolates the application being used by the user from the host computer or operating system. For example, Java applets run in a Java VM (JVM) that has no access to the host operating system. Because versions of the VM are written for various computer platforms, any application written for the VM can be operated on any of the platforms, instead of having to produce separate versions of the application for each computer and operating system. The application may then be run on a computer using, for example, an interpreter such as Java. Java, which is well known in the industry, is extremely portable, flexible and powerful with respect to allowing applications to, for example, access mobile phone features. Thus, Java has been widely used by developers to develop portable applications that can be run on a wide variety of electronic devices or computers without modification.

Particularly in mobile environments where resources are scarce due to consumer demand to reduce the cost and size of mobile terminals, it is often important to conserve or reuse resources whenever possible. In this regard, efforts have been exerted to try to conserve or reclaim resources of VMs when the resources are no longer needed by a particular application. An application consumes resources during operation. When the application is no longer in use, some of the resources are reclaimable (e.g. memory) while other resources are not reclaimable (e.g. used processing time). Some reclaimable resources include resources that are explicitly allocated by an application code and application programming interface (API) methods called by the application code such as, for example, plain Java objects. With regard to these reclaimable resources, garbage collection techniques have been developed to enhance reclamation of these resources. For example, once an object such as a Java object is no longer referenced it may be reclaimed by a garbage collector of the VM. Other operations aimed at conserving or reclaiming resources are also continuously being developed and employed. However, in some cases, the execution of even the processes aimed at conserving or reclaiming resources may themselves consume resources and/or require extra administration. Accordingly, it may be desirable to explore other ways to improve performance.

### BRIEF SUMMARY

A method, apparatus and computer program product are therefore provided that may enable provision of an instruction predictor for a VM such as, for example, a Java VM. Accordingly, for example, the VM may have an idea of which instructions to expect next so that the VM may prepare itself for processing the expected instructions to thereby increase processing speed. Moreover, in some cases, the knowledge of potential future instructions (e.g., via prediction of future instructions) may enable the VM to limit or restrict the use of certain processes (e.g., resource reclamation processes, adaptive optimization, just in time compilation) when the operations expected to occur are not likely to benefit from the operation of such processes. For example, if the processing expected to take place does not involve memory, the garbage collector may be suppressed in order to avoid expending garbage collection administration resources when such resources are not expected to be needed, or if it is known as to which variables will likely be used next, such variables may be stored in a cache or register.

In one exemplary embodiment, a method for providing an instruction predictor for a virtual machine is provided. The method may include training a neural network to predict a future instruction corresponding to a current instruction based on past instructions provided to the neural network, and providing the future instruction predicted to a virtual machine to enable the virtual machine to manage operation of the virtual machine based on the future instruction.

In another exemplary embodiment, an apparatus for providing an instruction predictor for a virtual machine is provided. The apparatus may include a processor and a memory storing executable instructions that in response to execution by the processor cause the apparatus to train a neural network to predict a future instruction corresponding to a current instruction based on past instructions provided to the neural network, and provide the future instruction predicted to a virtual machine to enable the virtual machine to manage operation of the virtual machine based on the future instruction.

In another exemplary embodiment, a computer program product for providing an instruction predictor for a virtual machine is provided. The computer program product includes at least one computer-readable storage medium having computer-executable program code instructions stored therein. The computer-executable program code instructions may include program code instructions for training a neural network to predict a future instruction corresponding to a current instruction based on past instructions provided to the neural network, and providing the future instruction predicted to a virtual machine to enable the virtual machine to manage operation of the virtual machine based on the future instruction.

Embodiments of the invention provide a method, apparatus and computer program product for providing an instruction predictor for a virtual machine. As a result, the virtual machine may be enabled to manage operations based on the expected future instructions the virtual machine is likely to encounter.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one example of a communication system according to an exemplary embodiment of the present invention;

FIG. 2 illustrates a schematic block diagram of an apparatus for enabling the provision of an instruction predictor for a VM according to an exemplary embodiment of the present invention;

FIG. 3 illustrates a block diagram of an exemplary structure of a predictor perceptron according to an exemplary embodiment of the present invention;

FIG. 4 illustrates a flow diagram of a learning process for the predictor perceptron according to an exemplary embodiment of the present invention;

FIG. 5 illustrates an example of operation of the learning process of FIG. 4 according to an exemplary embodiment of the present invention; and

FIG. 6 illustrates a flowchart of a method of selectively executing finalizers in accordance with an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Some embodiments of the present invention may provide a mechanism by which improvements may be experienced in relation to processing speed of a device employing a VM. In this regard, for example, some embodiments may provide enablement for a virtual machine to employ a predictor perceptron configured to learn to generate a probabilistic expectation of what instructions to expect in the future based on past instructions. Accordingly, the VM may suspend, modify or otherwise tailor its operations based on the probabilistic expectation in order to improve overall processing speed of the virtual machine.

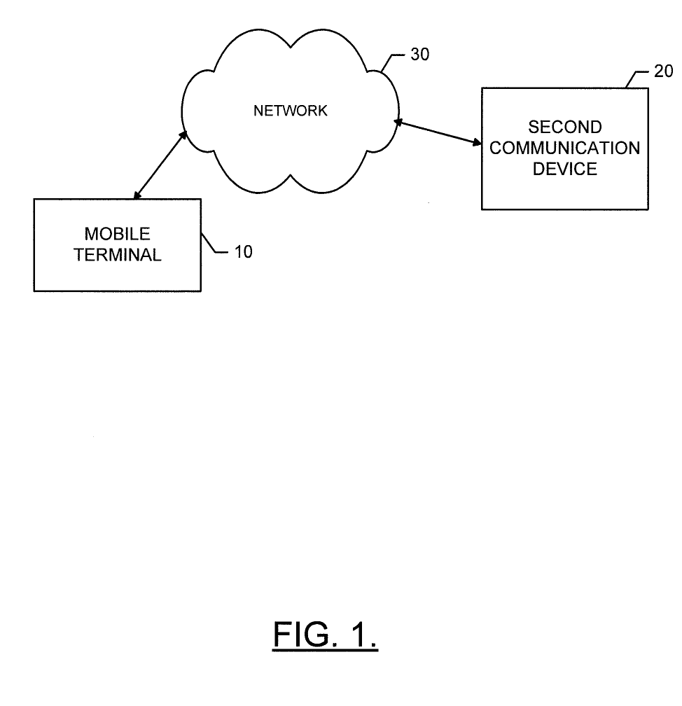

FIG. 1 illustrates a generic system diagram in which a device such as a mobile terminal 10, which may benefit from embodiments of the present invention, is shown in an exemplary communication environment. As shown in FIG. 1, an embodiment of a system in accordance with an example embodiment of the present invention may include a first communication device (e.g., mobile terminal 10) and a second communication device 20 capable of communication with each via a network 30. In some cases, embodiments of the present invention may further include one or more network devices with which the mobile terminal 10 and/or the second communication device 20 may communicate to provide, request and/or receive information. It should be noted that although FIG. 1 shows a communication environment that may support client/server application execution, in some embodiments, the mobile terminal 10 and/or the second communication device 20 may employ embodiments of the present invention without any network communication. As such, for example, applications executed locally at the mobile terminal 10 and/or the second communication device 20 may benefit from embodiments of the present invention. However, it should be noted that speed optimization techniques such as those described herein can be used not only in embedded devices, but in desktops and servers as well.

The network 30, if employed, may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 and the second communication device 20 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the mobile terminal 10 and/or the second communication device 20 via the network 30. By directly or indirectly connecting the mobile terminal 10 and/or the second communication device 20 and other devices to the network 30, the mobile terminal 10 and/or the second communication device 20 may be enabled to communicate with the other devices or each other, for example, according to numerous communication protocols including Hypertext Transfer Protocol (HTTP) and/or the like, to thereby carry out various communication or other functions of the mobile terminal 10 and the second communication device 20, respectively.

Furthermore, although not shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In example embodiments, the first communication device (i.e., the mobile terminal 10) may be a mobile communication device such as, for example, a personal digital assistant (PDA), wireless telephone, mobile computing device, camera, video recorder, audio/video player, positioning device, game device, television device, radio device, or various other like devices or combinations thereof. The second communication device 20 may be a mobile or fixed communication device. However, in one example, the second communication device 20 may be a remote computer or terminal such as a personal computer (PC) or laptop computer.

In an exemplary embodiment, either or both of the mobile terminal 10 and the second communication device 20 may be configured to include a VM modified in accordance with an exemplary embodiment of the present invention. As such, as indicated above, the execution of one or more applications associated with the VM may be accomplished with or without any connection to the network 30 of FIG. 1 and thus FIG. 1 should be understood to provide one example of some devices that may employ an embodiment of the present invention within a typical environment that such devices may often be found.

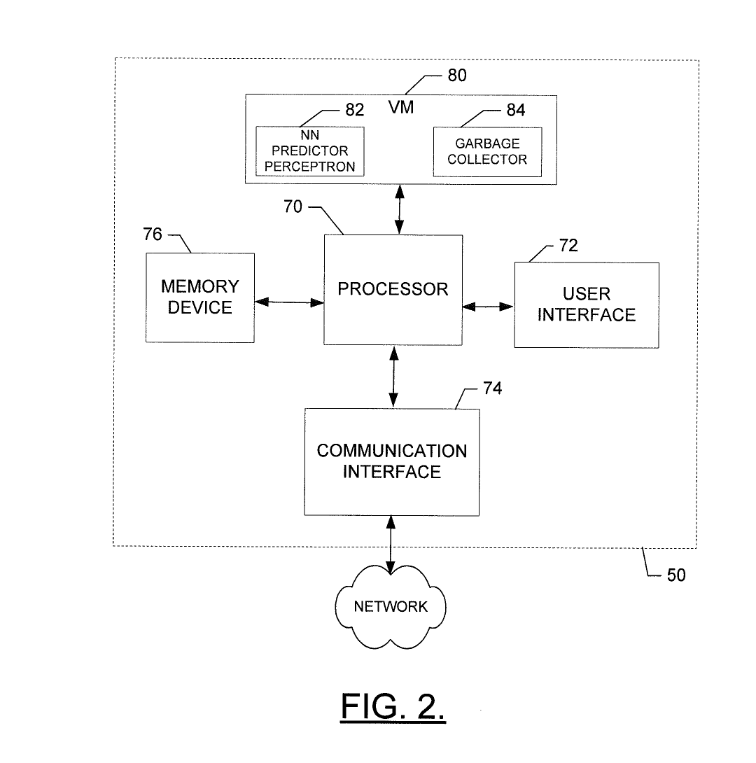

FIG. 2 illustrates a schematic block diagram of an apparatus for providing a predictor perceptron configured to learn to generate a probabilistic expectation of what instructions to expect in the future based on past instructions according to an exemplary embodiment of the present invention. An exemplary embodiment of the invention will now be described with reference to FIG. 2, in which certain elements of an apparatus 50 for providing a predictor perceptron configured to learn to generate a probabilistic expectation of what instructions to expect in the future based on past instructions are displayed. The apparatus 50 of FIG. 2 may be employed, for example, on a communication device (e.g., the mobile terminal 10 and/or the second communication device 20) or a variety of other devices (e.g., desktops and servers), both mobile and fixed (such as, for example, any of the devices listed above). However, it should be noted that the components, devices or elements described below may not be mandatory and thus some may be omitted in certain embodiments.

Referring now to FIG. 2, an apparatus for providing a predictor perceptron configured to learn to generate a probabilistic expectation of what instructions to expect in the future based on past instructions is provided. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70, which may in some cases otherwise be a general purpose processing element or other functionally configurable circuitry if not for the specific configuration provided by the instructions, to perform the algorithms and/or operations described herein. However, in some cases, the processor 70 may be a processor of a specific device (e.g., a mobile terminal or server) adapted for employing embodiments of the present invention by further configuration of the processor 70 by instructions for performing the algorithms and/or operations described herein.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like.

In an exemplary embodiment, the processor 70 may be embodied as, include or otherwise control a virtual machine (VM) 80. The VM 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the VM 80 as described below. Thus, in examples in which software is employed, a device or circuitry (e.g., the processor 70 in one example) executing the software forms the structure associated with such means. In this regard, for example, the VM 80 may be configured to provide, among other things, for the training of a neural network to predict a future instruction corresponding to a current instruction based on past instructions provided to the neural network, and to provide the future instruction predicted to a VM in order to enable the VM to manage operation of the VM based on the future instruction.

In an exemplary embodiment, the VM 80 may run on a framework of the mobile terminal 10 or second communication device 20 of FIG. 1 (or any other device on which the VM 80 is deployable). The framework of the device on which the VM 80 runs may include the operating system of the mobile terminal 10 or second communication device 20. Furthermore, the VM 80 may be embodied as any device or means embodied in either hardware, computer program product, or a combination of hardware and software that is capable of executing applications and/or instructions like a computer otherwise would, but in a manner that isolates the VM 80 from the operating system of the device on which the VM 80 is employed. In an exemplary embodiment, however, the VM 80 may be embodied in software as instructions that are stored on a memory of the mobile terminal 10 or second communication device 20 and executable by a processor (e.g., processor 70).

In an exemplary embodiment, the VM 80 may include or otherwise be in communication with a neural network (NN) predictor perceptron 82 (or simply predictor perceptron). The predictor perceptron 82 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the predictor perceptron 82 as described below. Thus, in examples in which software is employed, a device or circuitry (e.g., the processor 70 in one example) executing the software forms the structure associated with such means. In this regard, for example, the predictor perceptron 82 may be configured to provide, among other things, for the learning of an instruction prediction algorithm and the provision of future instruction predictions based on the learned algorithm.

In some embodiments, the VM 80 may further include one or more resource conservation entities and/or one or more resource reclamation entities. Such resource conservation or reclamation entities may be devices or means embodied in either hardware, computer program product, or a combination of hardware and software that are configured to perform operations associated with conserving resource consumption or reclaiming unused resources, respectively. As an example, a resource reclamation entity may include a garbage collector 84. The garbage collector 84 may be any means such as a device or circuitry embodied in either hardware, computer program product, or a combination of hardware and software that is capable of identifying and freeing all objects that are no longer referenced and therefore are not reachable. In an exemplary embodiment, the garbage collector 84 may operate to free the objects which had all references cleared by operation of the application to clear all references to objects that will not be used in background operation among other things. In this regard, for example, objects from resources that are explicitly allocated by an application code and API methods called by the application code may be reclaimed using the garbage collector 84 following the transition from foreground operation to background operation. As another example, instruction optimization may be accomplished by earlier calculation of future operands and storing the earlier calculations in a cache or register.

Accordingly, in one example embodiment, the predictor perceptron 82 is configured to communicate information to the VM 80 regarding a probabilistic expectation of instructions to expect in the future so that the VM 80 is enabled to suppress or otherwise manage operations of resource conservation or reclamation entities like the garbage collector 84, if such devices are not likely to be needed in association with the expected instructions. Thus, embodiments of the present invention may enable the VM 80 to improve processing speed by configuring itself ahead of time for expected instructions and/or suppressing unnecessary operations.

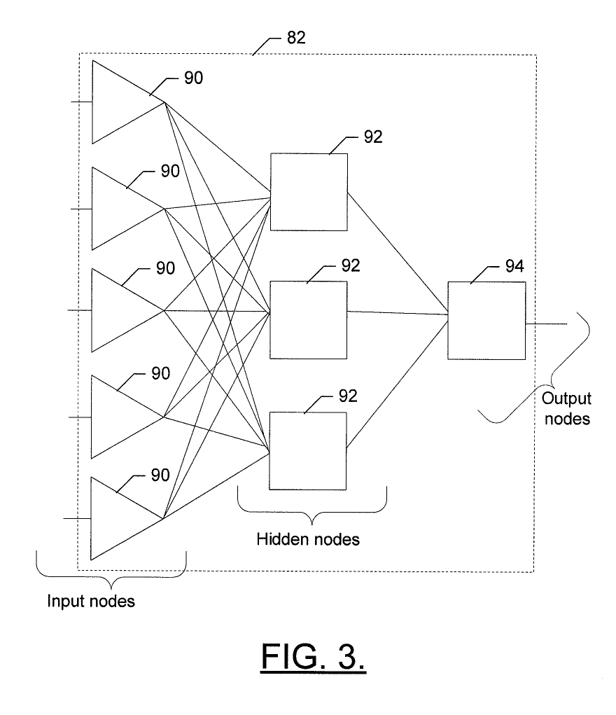

FIG. 3 illustrates an exemplary structure of the predictor perceptron 82 according to an exemplary embodiment. In this regard, as shown in FIG. 3, the predictor perceptron 82 may be embodied as a neural network including a plurality of neurons or nodes. Each node may be structurally similar, although nodes may have different connections. Each node may include an input for receiving a value that may then be weighted according to the configuration of the corresponding node and the weighted value may then be compared to a threshold. If the weighted value exceeds the threshold, the corresponding node may output a high value (e.g., a logical one), but if the weighted value is below the threshold, the corresponding node may output a low value (e.g., a logical zero) to the node or nodes to which the output of the corresponding node is connected. The weighting applied in each respective node may be changeable (e.g., by a learning process) as described in greater detail below. Each node may be a hardware device or may be embodied in software as a result of the execution of stored instructions by a processing device (e.g., the processor 70).

In an exemplary embodiment, the predictor perceptron 82 may include an input node layer, a hidden node layer and an output node layer. The input node layer may include one or more input nodes 90 that may be configured to receive values (e.g., input vectors) that may correspond, for example, to instructions associated with one or more applications. The values received may then be weighted and thresholded according to the configuration of each respective input node 90 and a result may then be output to each hidden node 92 of the hidden node layer to which each respective input node 90 is connected. Similar processing to that accomplished at the input nodes 90 may be performed at each hidden node 92 and an output may then be provided to each output node 94 of the output node layer to which each hidden node 92 is connected. It should be noted that although FIG. 3 illustrates an example in which there are five input nodes 90, three hidden nodes 92 and one output node 94, other structures with other numbers of nodes in each layer and different numbers of inner layers may alternatively be employed. Thus, the embodiment of FIG. 3 merely illustrates one example structure of the predictor perceptron 82.

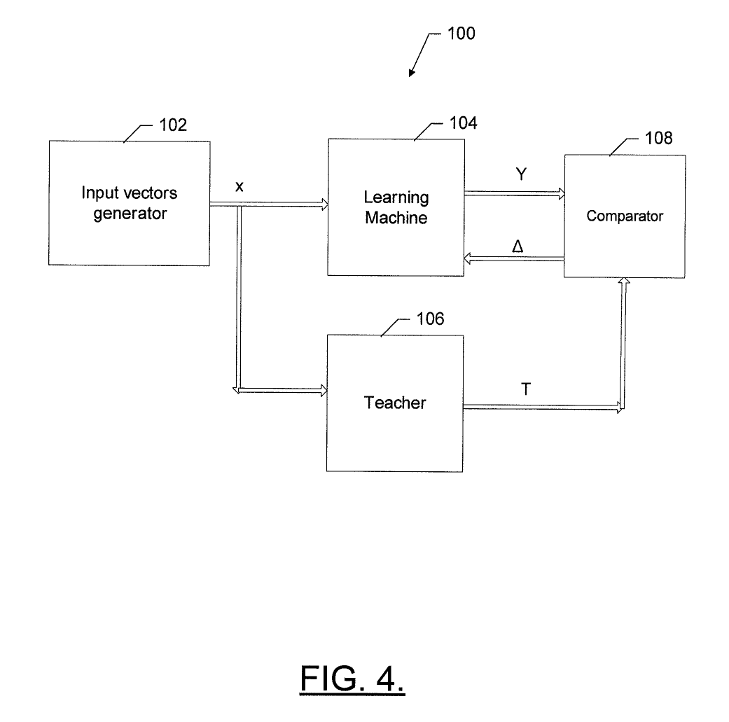

As indicated above, the nodes of the predictor perceptron 82 may be configured via a learning process (e.g., to adjust the weights applied to values received at one or more nodes). FIG. 4 illustrates a flow diagram of a learning process for the predictor perceptron 82 according to an exemplary embodiment. In other words, FIG. 4 illustrates a neural network learning algorithm 100. Initially, an input vector generator 102 may provide an input signal x to a learning machine 104. The learning machine 104 may be an example of the predictor perceptron 82 in a learning mode. The learning machine 104 may process the input signal x according to the configuration of the predictor perceptron 82 and produce an output signal Y. The input vector generator 102 may also provide the input signal x to a teacher 106. The teacher 106 may generate a teaching signal T in response to receipt of the input signal x. The teaching signal T from the teacher 106 and the output signal Y from the learning machine 104 may each be provided to a comparator 108 in the form of a comparison block. The comparator 108 may provide an error value A defining a difference between the teaching signal T and the output signal Y. The error value A may then be used by the learning machine 104 to change weights associated with one or more of the nodes of the predictor perceptron 82 based on the error value A in order to train the learning machine 104.

In an exemplary embodiment, the input vector generator 102 may be any device that may provide instructions or bytecodes or time series of any nature to the learning machine 104 and/or the teacher 106. As such, for example, the input vector generator 102 may be a device or circuitry configured to provide instructions corresponding to an application or applications that the predictor perceptron 82 may have executed in the past or may be expected to execute in the future. Thus, the input vector generator 102 may provide an input of instructions to the predictor perceptron 82 that may be predicted in the future.

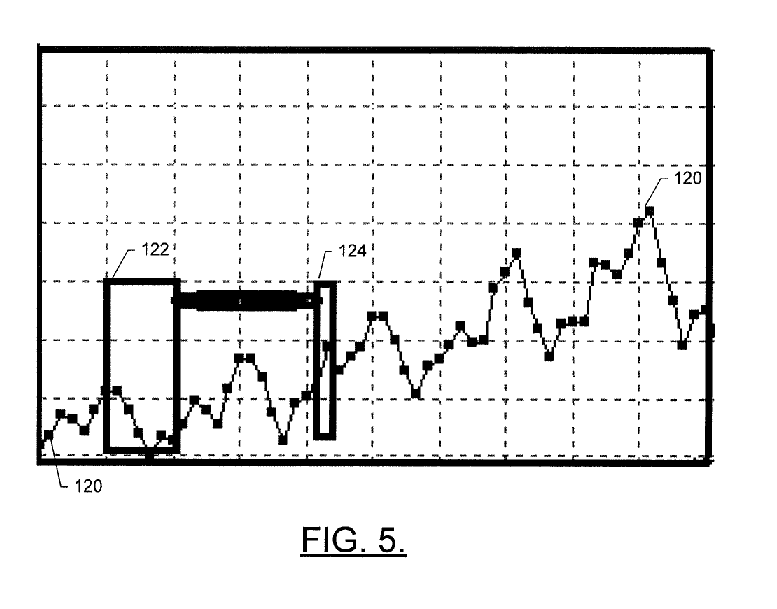

In an exemplary embodiment, the teacher 106 and the comparator 108 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the teacher 106 and the comparator 108, respectively, as described herein. In some cases, the teacher 106 and the comparator 108 may be embodied by the same or different devices or circuitry. Further operation of the teacher 106 will be described below in reference to FIG. 5.

FIG. 5 illustrates an example of operation of the learning algorithm 100 of FIG. 4 according to an exemplary embodiment. In an exemplary embodiment, operation of the learning algorithms 100 may be accomplished by the processor 70 either by execution of stored software instructions defining operations associated with execution of the learning algorithm 100, by operation in accordance with hard coded instructions within the processor 70, or by a combination of the preceding.

FIG. 5 shows a plurality of input vectors 120, each of which may be a value associated with instructions provided from the input vector generator 102 over time. FIG. 5 also shows two windows that may be defined for enabling predictor perceptron 82 learning in a learning stage during operation of the learning algorithm 100 and predictor perceptron 82 prediction after learning is complete. The windows may include a wide window 122 including a plurality of input values from the input signal x, and a narrow window 124 including a single value or instruction corresponding to the teaching signal T. In an exemplary embodiment, the wide window 122 and the narrow window 124 may have a fixed distance therebetween. Thus, for example, during the learning stage, the wide window 122 may include therein a time series of points (e.g., five points) defining a width for the wide window 122 corresponding to the number of input vectors input into the predictor perceptron 82 at one instant. Meanwhile, the narrow window 124 includes one input vector a fixed distance away from the wide window 122 and therefore representing a value at some point in the future relative to the wide window 122. The teaching signal T, as provided by the narrow window 124, therefore represents a time series of future values that correspond to the values of the wide window 122 at each respective time as the windows shift from left to right in time. The error value A determined by the comparator 108 may then be used to provide feedback to the learning machine 104 to change weights of nodes within the predictor perceptron 82.

After running the learning algorithm 100 for a given period of time, the predictor perceptron 82 may become trained to “predict” a future value based on the current series of values defined in the wide window 122 based on past relationships between values in the wide window 122 and the narrow window 124. In an exemplary embodiment, the learning algorithm 100 may be employed until learning criteria are met. In some cases, the learning criteria may be defined by a predetermined period of time or a predetermined error value (e.g., Empiric Risk Minimization). Thus, for example, the learning algorithm 100 may be employed for a set time period or until the error value A is reduced to a predetermined value or threshold. As such, for example, if the error value A is reduced below a particular threshold, it may be assumed that the predictor perceptron 82 is sufficiently trained to provide relatively good quality predictions of future instructions based on instructions encountered at the current time (e.g., in the wide window 122) and the predictor perceptron 82 may shift to operation in a prediction stage. In the prediction stage, values in the wide window 122 may represent a time series of values most recently encountered and the value in the narrow window 124 may represent a predicted value. The predicted value may therefore be communicated to the VM 80 to enable the VM 80 to manage processes based on the predicted value.

Accordingly, exemplary embodiments of the present invention may be used to provide the VM 80 with the capability to suppress or otherwise manage certain activities (e.g., garbage collection activity by the garbage collector 84) based on the expectation of what instructions to expect in the future as provided by a trained predictor perceptron 82. However, some embodiments may be configured to not just provide a single prediction with respect to instructions to be expected in the future, but instead a probabilistic based prediction. In other words, the predictor perceptron 82 may be trained by the learning algorithm 100 to provide predicted future instructions corresponding to current instructions based on past instructions processed during the learning stage. In this regard, for example, if the same series of inputs corresponds to three different possible future instructions, but of ten instances in which the series was encountered during training a first of the three different possible future instructions was encountered eight times and the other possible future instructions were each only encountered once, the predictor perceptron 82 may be trained to provide an indication to the VM 80 that there is an eighty percent chance of the first of the three different possible future instructions and a ten percent chance of each of the other possible future instructions. The VM 80 may therefore make determinations as to which processes, if any, may be suppressed or otherwise managed in order to increase processing speed of the VM 80.

In some embodiments, the predictor perceptron 82 may be configured to provide information regarding predictions of one or more possible future instructions to the VM 80 automatically on a periodic or continuous basis. However, in some alternative embodiments, the predictor perceptron 82 may only provide prediction related information to the VM 80 in response to a request for such information from the VM 80.

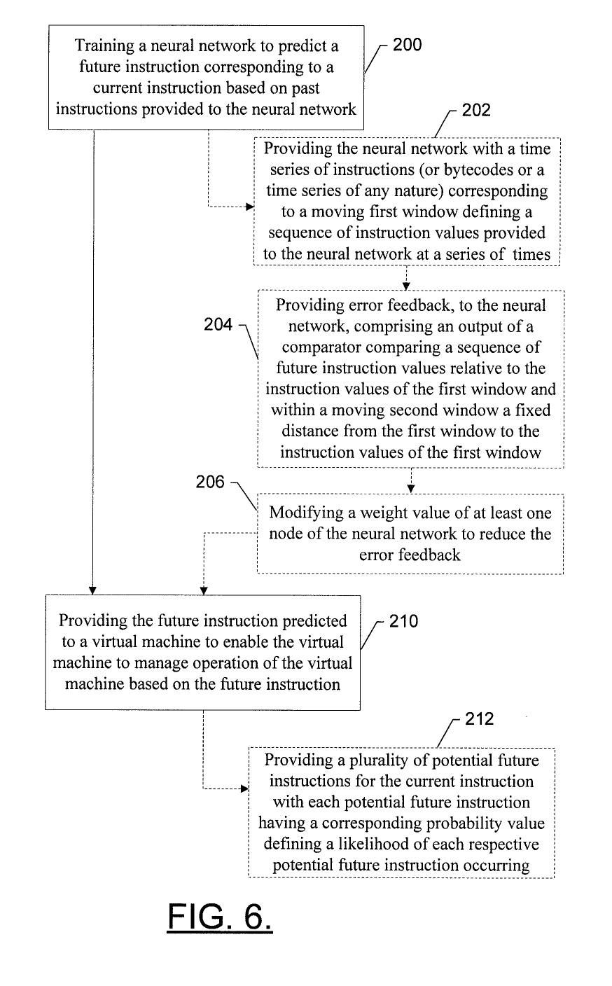

FIG. 6 is a flowchart of a system, method and program product according to exemplary embodiments of the invention. It will be understood that each block or step of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (i.e., hardware) to produce a machine, such that the resulting computer or other programmable apparatus embody means for implementing the functions specified in the flowchart block(s) or step(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing an instruction predictor for a virtual machine, as shown in FIG. 6, includes training a neural network to predict a future instruction corresponding to a current instruction based on past instructions provided to the neural network at operation 200 and providing the future instruction predicted to a virtual machine to enable the virtual machine to manage operation of the virtual machine based on the future instruction at operation 210.

In some embodiments, certain ones of the operations above may be modified or further amplified as described below. Some examples of modifications to the operations above are shown in dashed lines in FIG. 6. It should be appreciated that each of the modifications or amplifications below may be included with the operations above either alone or in combination with any others among the features described herein. In this regard, for example, in one exemplary embodiment, training the neural network may include providing the neural network with a time series of instructions corresponding to a moving first window defining a sequence of instruction values provided to the neural network at a series of times at operation 202, providing error feedback, to the neural network, comprising an output of a comparator comparing a sequence of future instruction values relative to the instruction values of the first window and within a moving second window a fixed distance from the first window to the instruction values of the first window at operation 204, and modifying a weight value of at least one node of the neural network to reduce the error feedback at operation 206. In some cases, modifying the weight value of at least one node of the neural network may include making modifications to the neural network until a value of the error feedback reaches at least a predetermined value. In some examples, training the neural network may include training the neural network until a training criteria is satisfied and shifting to a prediction stage in response to satisfaction of the training criteria.

In an exemplary embodiment, providing the future instruction may include providing a plurality of potential future instructions for the current instruction with each potential future instruction having a corresponding probability value defining a likelihood of each respective potential future instruction occurring as shown at operation 212. In some cases, the future instruction may be provided to the virtual machine in response to a request from the virtual machine. In some examples, enabling the virtual machine to manage operation of the virtual machine based on the future instruction may include enabling the virtual machine to suppress an operation determined to be unlikely to be necessary based on the future instruction.

In an exemplary embodiment, an apparatus for performing the method of FIG. 6 above may comprise a processor (e.g., the processor 70) configured to perform some or each of the operations (200-212) described above. The processor may, for example, be configured to perform the operations (200-212) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-212 may comprise, for example, the processor 70, the VM 80, the predictor perceptron 82, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
training a neural network to predict a future instruction corresponding to a current instruction based on past instructions provided to the neural network; and
providing the future instruction predicted to a virtual machine to enable the virtual machine to manage operation of the virtual machine based on the future instruction.

2. A method according to claim 1, wherein training the neural network comprises:
providing the neural network with a time series of instructions corresponding to a moving first window defining a sequence of instruction values provided to the neural network at a series of times;
providing error feedback, to the neural network, comprising an output of a comparator comparing a sequence of future instruction values relative to the instruction values of the first window and within a moving second window a fixed distance from the first window to the instruction values of the first window; and
modifying a weight value of at least one node of the neural network to reduce the error feedback.

3. A method according to claim 2, wherein modifying the weight value of at least one node of the neural network comprises making modifications to the neural network until a value of the error feedback reaches at least a predetermined value.

4. A method according to claim 1, wherein training the neural network comprises training the neural network until a training criteria is satisfied and shifting to a prediction stage in response to satisfaction of the training criteria.

5. A method according to claim 1, wherein providing the future instruction comprises providing a plurality of potential future instructions for the current instruction with each potential future instruction having a corresponding probability value defining a likelihood of each respective potential future instruction occurring.

6. A method according to claim 1, wherein providing the future instruction predicted to the virtual machine comprises providing the future instruction to the virtual machine in response to a request from the virtual machine.

7. A method according to claim 1, wherein providing the future instruction predicted to the virtual machine to enable the virtual machine to manage operation of the virtual machine based on the future instruction comprises enabling the virtual machine to suppress an operation determined to be unlikely to be necessary based on the future instruction.

8. A computer program product comprising at least one computer-readable storage medium having computer-executable program code instructions stored therein, the computer-executable program code instruction comprising:
program code instructions for training a neural network to predict a future instruction corresponding to a current instruction based on past instructions provided to the neural network; and
program code instructions for providing the future instruction predicted to a virtual machine to enable the virtual machine to manage operation of the virtual machine based on the future instruction.

9. A computer program product according to claim 8, wherein program code instructions for training the neural network include instructions for:
providing the neural network with a time series of instructions corresponding to a moving first window defining a sequence of instruction values provided to the neural network at a series of times;
providing error feedback, to the neural network, comprising an output of a comparator comparing a sequence of future instruction values relative to the instruction values of the first window and within a moving second window a fixed distance from the first window to the instruction values of the first window; and
modifying a weight value of at least one node of the neural network to reduce the error feedback.

10. A computer program product according to claim 9, wherein program code instructions for modifying the weight value of at least one node of the neural network include instructions for making modifications to the neural network until a value of the error feedback reaches at least a predetermined value.

11. A computer program product according to claim 8, wherein program code instructions for training the neural network include instructions for training the neural network until a training criteria is satisfied and shifting to a prediction stage in response to satisfaction of the training criteria.

12. A computer program product according to claim 8, wherein program code instructions for providing the future instruction include instructions for providing a plurality of potential future instructions for the current instruction with each potential future instruction having a corresponding probability value defining a likelihood of each respective potential future instruction occurring.

13. A computer program product according to claim 8, wherein program code instructions for providing the future instruction predicted to the virtual machine to enable the virtual machine to manage operation of the virtual machine based on the future instruction include instructions for enabling the virtual machine to suppress an operation determined to be unlikely to be necessary based on the future instruction.

14. An apparatus comprising a processor and a memory storing executable instructions that in response to execution by the processor cause the apparatus to at least perform the following:
training a neural network to predict a future instruction corresponding to a current instruction based on past instructions provided to the neural network; and
providing the future instruction predicted to a virtual machine to enable the virtual machine to manage operation of the virtual machine based on the future instruction.

15. An apparatus according to claim 14, wherein the instructions for training the neural network comprise instructions for:
providing the neural network with a time series of instructions corresponding to a moving first window defining a sequence of instruction values provided to the neural network at a series of times;
providing error feedback, to the neural network, comprising an output of a comparator comparing a sequence of future instruction values relative to the instruction values of the first window and within a moving second window a fixed distance from the first window to the instruction values of the first window; and
modifying a weight value of at least one node of the neural network to reduce the error feedback.

16. An apparatus according to claim 15, wherein the instructions for modifying the weight value of at least one node of the neural network comprise instructions for making modifications to the neural network until a value of the error feedback reaches at least a predetermined value.

17. An apparatus according to claim 14, wherein instructions for training the neural network comprise instructions for training the neural network until a training criteria is satisfied and shifting to a prediction stage in response to satisfaction of the training criteria.

18. An apparatus according to claim 14, wherein instructions for providing the future instruction comprise instructions for providing a plurality of potential future instructions for the current instruction with each potential future instruction having a corresponding probability value defining a likelihood of each respective potential future instruction occurring.

19. An apparatus according to claim 14, wherein instructions for providing the future instruction predicted to the virtual machine comprise instructions for providing the future instruction to the virtual machine in response to a request from the virtual machine.

20. An apparatus according to claim 14, wherein instructions for providing the future instruction predicted to the virtual machine to enable the virtual machine to manage operation of the virtual machine based on the future instruction comprise instructions for enabling the virtual machine to suppress an operation determined to be unlikely to be necessary based on the future instruction.
